(19) United States
(12) Patent Application Publication
(10) Pub. No.: US 2012/0245908 A1
(43) Pub. Date: Sep. 27, 2012

(54) METHOD FOR DETERMINING THE STRESS FREE TEMPERATURE OF THE RAIL AND/OR THE TRACK RESISTANCE

(75) Inventor: Eric Berggren, Falun (SE)

(73) Assignee: EBER DYNAMICS AB, Falun (SE)

(21) Appl. No.: 13/514,177

(22) PCT Filed: Dec. 3, 2010
(86) PCT No.: PCT/SE2010/000284

§ 371 Date: Jun. 6, 2012

(30) Foreign Application Priority Data
Dec. 7, 2009 (SE) 0901526-4

(51) Int. Cl. G06F 17/10

(52) U.S. Cl. 703/2

(57) ABSTRACT

A method and device for determining at least a first parameter of a track. The method includes providing a first track geometry quality data associated to at least one point along a rail at a first temperature, providing a second track geometry quality data associated to at least one point at a second temperature, and describing a difference between the first and second track geometry quality data using a model. The model relates the first and second track geometry quality data with associated temperatures to stress free temperature and/or track resistance, and estimates the stress free temperature and/or track resistance in at least one point based on the model.

### TECHNICAL FIELD

The present invention relates to a method for determining at least a first parameter of a track, said parameters including at least stress free temperature and/or track resistance.

### BACKGROUND ART

Today, track recording cars as well as unattended track geometry measurement systems are used for measuring track geometry quality. These systems are arranged to make accurate measurements of many parameters, among them lateral and vertical alignment, track gauge, cross level and curvature. Maintenance is planned on the basis of such measurements and the motive for such measurements can be to assure a safe and comfortable travel by trains.

Track buckling is formation of large lateral misalignments in railway track, sometimes resulting in train derailments. Buckles are typically caused by a combination of three major factors: high compressive forces, weakened track conditions, and vehicle loads (train dynamics).

Compressive forces result from stresses induced in a constrained rail by temperature above its “stress free” state, and from mechanical sources such as train braking and acceleration.

The temperature of the rail at the stress-free state is known as the stress free temperature (SFT) (i.e. the temperature at which the rail experiences zero longitudinal force). Initially, the rail's installation temperature or anchoring temperature is the rail's SFT. Hence, at rail temperatures above the neutral, compressive forces are generated, and at temperatures below the neutral, tensile forces are developed. Track maintenance practices address the high thermal load problem by anchoring the rail at (neutral) temperature of 10-40° C. depending on yearly average temperature.

Weakened track conditions impacting the tracks buckling potential include: reduced track resistance, lateral alignment defects, and lowered rail SFT. Track resistance is the ability of the ballast, sleepers and fasteners to provide lateral and longitudinal strength to maintain track stability. Resistance is lowered if ballast is missing from under or between the sleepers, or from the shoulder. A full ballast section is important, especially on curves. Track resistance is lowered when ballast is disturbed. Tamping (surfacing), sleeper renewal and undercutting operations will weaken ballast resistance by a high degree. Longitudinal resistance offered to the rail/sleeper structure by adequate rail anchoring is important to prevent rail running and hence the decrease of rail neutral temperature.

To prevent track buckling, SFT and track resistance have to be monitored. Currently there exist a couple of methods to monitor SFT e. g.
Cut-method (The rail is cut and the gap is an estimate of SFT). This is a destructive method, a new weld is needed.
A method wherein fasteners are released and rail lifted. Lifting force is proportional to SFT

Common to most of them is that measurements are taken in one position at a time. This makes the methods time consuming and hence interval between measurements may be stretched (both in time and position along the track).

GB 2 362 471 describes a method of determining the stress free temperature of railway rails, which are longitudinally stressed. The method comprises the steps of removing an annular section of the rail, determining the change in strain as a result of the removal of the annular section and determining the stress free temperature of the rail based on the determined change in strain, rail temperature, the coefficient of linear expansion and Young's modulus of the rail material.

U.S. Pat. No. 5,386,727 describes an ultrasonic based method for determining the longitudinal stress in a rail section based on the alteration of an ultrasonic signal transmitted through said rail.

### SUMMARY OF THE INVENTION

It is one object of the invention to provide an improved way of determining the stress free temperature and/or track resistance.

This is in one example of the invention solved by way of a method for determining at least a first parameter of a track. The method comprises the steps of
providing first track geometry quality data associated to at least one point along a rail at a first temperature,
providing second track geometry quality data associated to said at least one point at a second temperature
describing a difference between the first and second track geometry quality data by means of a model relating the first and second track geometry quality data with associated temperatures to stress free temperature and/or track resistance, and
estimating stress free temperature and/or track resistance in said at least one point based on said model.

In using this method, information related to stress free temperature and/or track resistance can be provided at an arbitrary number of positions along a rail only using data related to track geometry quality, such as lateral alignment, and temperature measurements. Further, measurements already made today can be used in the method minimizing possession of track for determining the parameters.

The model is for example a beam model such as an Euler-Bernoulli model, a black box model, a grey box model or a finite element model.

In one example, the step of estimating stress free temperature and/or track resistance comprises numerically calculating higher derivatives of lateral alignment so as to provide a beam model without differentials.

In one example of the method, the step of providing first track geometry quality data comprises providing a first series of track geometry quality data comprising data associated to a plurality of first measure points along the rail, and the step of providing second track geometry quality data comprises providing a second series of track geometry quality data comprising data associated to a plurality of second measure points along the rail. The method further comprises a step of correlating the first series track geometry quality data with the second series track geometry quality data.

The method can comprise providing a measure of the first temperature at each first measure point and associating the first temperature value with the corresponding first track geometry quality data, and providing a measure of the second temperature at each second measure point and associating the second temperature value with the corresponding second track geometry quality data.

In one embodiment the method also comprises the steps of performing track buckle risk analysis based on the used model. The step of performing track buckle risk analysis comprises for example inserting the estimated stress free temperature in each said at least one point in the model, and determining the sensitivity of alignment of the rail to variation of track buckling parameters such as temperature and/or track resistance based on the model.

The invention also comprises a device for determining at least a first parameter of a track. The device comprises a registration unit arranged to register first track geometry quality data along with associated first temperature data and second track geometry quality data along with associated second temperature data, and processing means arranged to set up a model relating the first and second track geometry quality data with associated temperatures to stress free temperature and/or track resistance, and to estimate stress free temperature and/or track resistance in said at least one point based on the model.

### BRIEF DESCRIPTION OF THE DRAWINGS

FIG. 1 is a flow chart over a method for determining stress free temperature and/or track resistance according to one example of the invention.

FIG. 2 shows a rail with parameters depicted related to lateral and vertical alignment.

FIG. 3 shows a track from above.

FIG. 4 is a flow chart illustrating a process for determining stress free temperature and/or track resistance based on a beam model.

FIG. 5 is a flow chart illustrating a process for performing track buckle risk analysis.

FIG. 6 is a block scheme over a device for calculating stress free temperature and/or track resistance.

### DETAILED DESCRIPTION

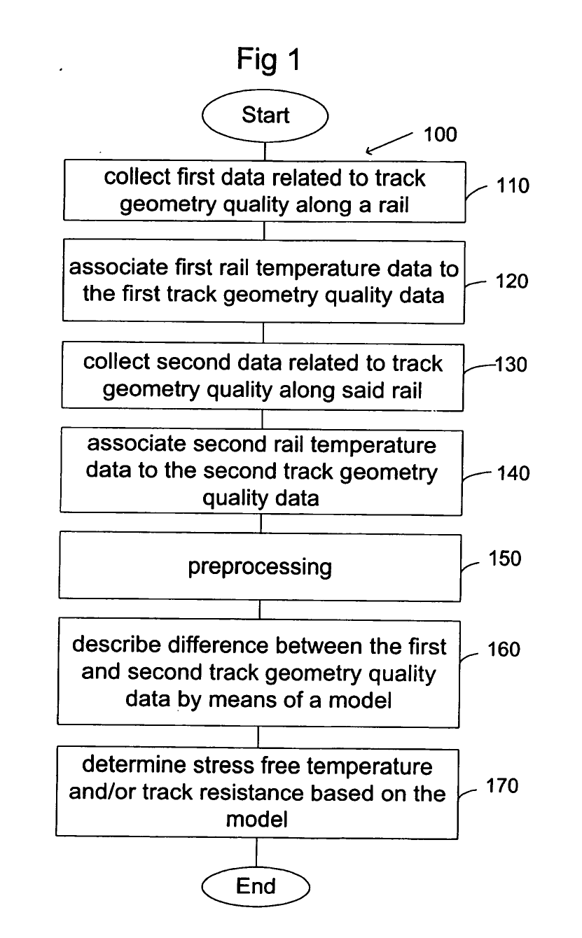

In FIG. 1, a method 100 for determining stress free temperature and/or track resistance in a railway track is described. The method comprises the following steps.

In a first step 110, a series of first data related to track geometry quality is measured. The track geometry quality measurements are performed at determined spatial intervals. In one example, the measurements are made at intervals smaller than each meter. For example, the interval between two measurements can be between 0.1 and 0.5 meter, such as approximately 0.25 meter. The measurements are in one example performed for each of the rails. The track geometry quality measurements comprise measurements of at least lateral alignment of the track. The track geometry quality measurements comprise further for example measurements of vertical alignment, track gauge, cross level and/or curvature. The measured first data is registered and saved.

In one example, track recording cars are used for measuring the track geometry quality. The cars are then travelling along the track and are performing the track geometry measurements accordingly. Simpler chord-based track recording cars measure the track with speeds between 30-120 km/h, for example. More advanced track recording cars measure the track with speeds between 120-320 km/h, for example. Measurement techniques can be either in contact (mechanical) or contact-less (inertial, laser-based) or a combination of both. If a chord measurement is used, the measurements will be transformed by a transfer function. There are methods to perform a re-colouring of such measurements.

In a second step 120, a first track temperature is associated to each first track geometry quality measurement. In one example, a non-contact temperature sensor such as infrared thermometer is used for performing track temperature measurements. The sensor or thermometer can then be directed towards the rail web or foot. When a track recording car is used, the non-contact temperature sensor is mounted on the car so as to be directed towards the rail web or foot. In a supplementary or alternative example, the track temperature is approximated with the ambient temperature with correction for sunlit rail. The temperature measurements are in one example updated with the same frequency as the track geometry quality measurements. Alternatively, the temperature measurements are updated with longer intervals than the track geometry quality measurements. An interpolation can then for example be made so as to provide one temperature value to each track geometry quality measurement.

In a third step 130, the procedure of the first step is repeated so as to provide a series of second data related to the track geometry quality. Accordingly, the track geometry quality measurements are performed at determined intervals such as at intervals smaller than each meter.

In a fourth step 140, the procedure of the second step 120 is repeated so as to associate a second track temperature to each second track geometry quality measurement. In one example the temperature difference between the temperatures in the first series and the second series is 20° C. or more. Alternatively, the temperature difference is 10° C. or more.

In one example (not shown) the procedure of providing a series of data related to the track geometry quality and associating it to track temperature is repeated an arbitrary number of times.

In a fifth step 150, the series of first and second track geometry quality data and/or the series of first and second temperature data is pre-processed. In one example, the pre-processing involves correlating the series of first and second track geometry quality data. This means that pairs of data are formed comprising a value from the first series and a value from the second track geometry quality data series related to substantially the same geographical position. In one example, the actual distance between the first and second value in each pair is smaller than 0.4 meters, and preferably less than 0.2 meters. If the measurement in the first to fourth steps can be made with high accuracy, the pre-processing step can be omitted.

If the measurements are performed at different rail temperatures, internal forces in the rail will have changed. This change will result in small geometrical changes which will effect the track geometry quality measurements. The governing parameters for the change are stress-free-temperature (SFT) and track resistance. In a sixth step 160, the difference between the first and second track geometry quality data is described by means of a model. The model is for example a beam model such as an Euler-Bernoulli model, a black box model, a grey box model or a finite element model. In the following, the description will relate to an Euler-Bernoulli model.

Thus, a beam model is used to describe the change of track geometry quality between different measurements of track geometry quality with different rail temperature. Unknown parameters in the beam theory equations are, as is understood from the above, stress free temperature (T_{SFT}) and track resistance. There is a plurality of beam models available. Thus, the beam theory equations can be set up in a numerous ways. An example of beam theory calculations will be later described in relation to FIG. 3.

In a seventh step 170, an estimation of the unknown parameters stress-free-temperature (SFT) and/or track resistance is made. Generally described, the estimation of the unknown parameters stress-free-temperature (SFT) and/or track resistance comprises the following steps described in relation to the Euler-Bernoulli model. First, the differentials in the beam equations are numerically differentiated based on the data provided in the first to fourth steps 110-140. This results in an equation system without differentials.

Thereafter, at least one of the remaining unknown parameters related to stress free temperature and track resistance is estimated. The estimation is for example done using adaptive filters, Kalman filters, and/or particle filters. Alternatively, the equation system is solved using iterative methods.

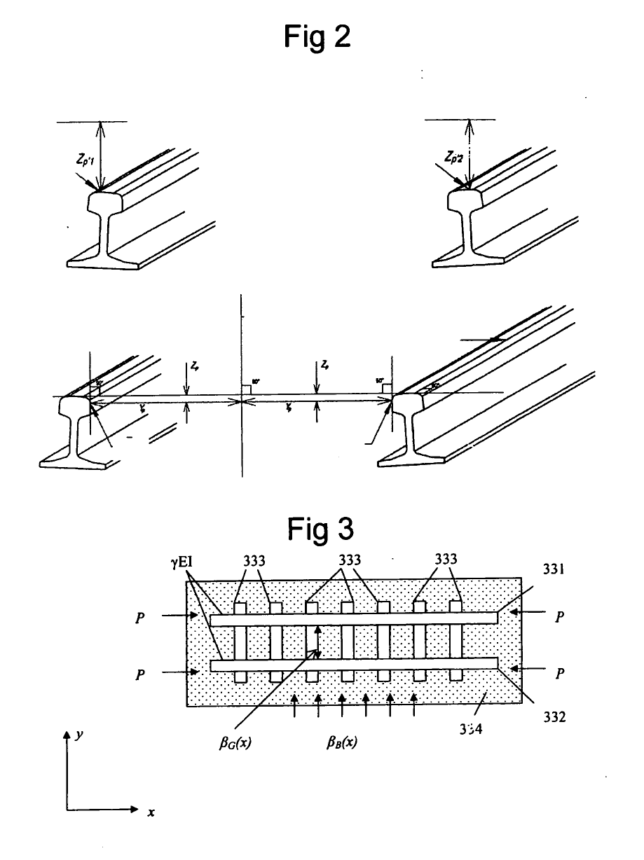

In FIG. 2, the terms vertical and lateral alignment is illustrated. Generally, both vertical and lateral alignment requires several consecutive measurements of the vertical/lateral position of the rail. It is calculated as a deviation z_{p′1}, z_{p′2}/yₚ from the mean vertical/lateral position. Measurements of lateral position are taken at a distance zₚ below the running surface. zₚ is often 14 mm. Alignment is often defined for different wavelength intervals where usually 3-25 m, 25-70 m and 70-150/200 m are used. In the upper part of FIG. 2, vertical alignment is illustrated. In the lower part of FIG. 2, lateral alignment is illustrated.

In FIG. 3, a track comprises two rails 331, 332. The rails 331, 332 extend in an x direction in a coordinate system aligned with the extension of the rail. Further, the coordinate system is so chosen that the rails lie in the xy-plane. The rails 331, 332 run on sleepers 333. The rails are fastened in the sleepers 333 by means of fasteners (not shown). A longitudinal force P_{long} acts on each rail 331, 332. The magnitude of the force P_{long} is dependent upon the deviation between the actual temperature and the stress-free temperature. In this example track resistance is modelled with the parameters γ, β_{B} and β_{G}. γ represent the increase of rail bending moment due to that the rails are clamped to the sleepers by fasteners. β_{B} represents the lateral (y-direction) elastic resistance from the ballast 334 to the sleepers and β_{G} represents the gauge resistance governed from the fasteners, also in y-direction. We will herein use the term track resistance as a generic term for linear elastic resistance from ballast β_{B}, linear elastic resistance from fasteners β_{G} and influence γ (compressing force) from fasteners.

In order to make an estimation of SFT and track resistance, a model which relates changes of lateral alignment with temperature and the searched parameters is needed. Beam theory from solid mechanics provides such models. In the following, the Euler-Bernoulli beam on a Winkler foundation is revised for this specific problem. Other models may also be used.

Each rail (beam) 331, 332 subjected to a longitudinal force P_{long}, linear elastic resistance β (from ballast and fasteners) and possible change of bending moment due to fasteners γ of the rail will follow equation 1.

$$γ EI \frac{{d}^{4} y}{d {x}^{4}} + {P}_{long} \frac{{d}^{2} y}{d {x}^{2}} - β y = 0 \qquad ( 1 )$$

The longitudinal force P_{long} is formed when the rail temperature T₁ is under or above the rail stress free temperature (T_{sft}) according to:

P_{long}=αEA(T₁−T_{sft}) (2)

E is the rail-steel elastic modulus, l is the area moment of inertia of the beam cross-section, A is the cross-section area of the rail, and a is the coefficient of heat expansion.

Another basic equation is the energy equation according to equation 3-4.

$$\begin{matrix}{U}_{tot} = 1 / 2 ( \int γ {EI ( \frac{{d}^{2} y}{d {x}^{2}} )}^{2} d x + \int β {y}^{2} d x + \int {{P}_{long} ( \frac{d y}{d x} )}^{2} d x ) & ( 3 ) \\ δ {U}_{tot} = 0 & ( 4 )\end{matrix}$$

The equations above are valid for a straight beam/rail. Rails in practice always have small vertical and lateral deviations. Compensation factors describing the stress-free geometrical position are needed. Also, each rail is anchored to the sleepers which have to be accounted for by combining two beams in one equation. Equation 5 describes this for time instance 1 (corresponding to rail temperature T₁) . . . for right rail 331 (denoted R in the following equations) and left rail 332 (denoted L in the following equations).

$$γ EI ( \frac{{d}^{4} {y}_{R 1}}{d {x}^{4}} + \frac{{d}^{4} {y}_{L 1}}{d {x}^{4}} ) + α EA ( {T}_{R 1} - {T}_{R\_SFT} ) \frac{{d}^{2} {y}_{R 1}}{d {x}^{2}} + α EA ( {T}_{L 1} - {T}_{L\_SFT} ) \frac{{d}^{2} {y}_{L 1}}{d {x}^{2}} - {β}_{B} \frac{{y}_{R 1} + {y}_{L 1}}{2} = γ EI ( \frac{{d}^{4} {y}_{R\_SFT}}{d {x}^{4}} + \frac{{d}^{4} {y}_{L \_SFT}}{d {x}^{4}} ) - {β}_{B} \frac{{y}_{R\_SFT} + {y}_{L\_SFT}}{2} \qquad ( 5 )$$

In equation 5, y_{R1}, y_{L1} indicates the lateral alignment at the right and left rails at time instance 1. Further, T_{R}_{_{—}}_{SFT}, T_{L}_{_{—}}_{SFT} indicates the SFT of the right and left rails. T_{R1} and T_{L1} are the measured rail temperatures. y_{R}_{_{—}}_{SFT}, y_{L}_{_{—}}_{SFT} represent the lateral alignment at the stress free temperature for the right and left rails.

The same equation can be formulated for another time instance 2. In this case the right hand side of the equations are similar and can be eliminated resulting in equation 6.

$$γ EI ( \frac{{d}^{4} {y}_{R 2}}{d {x}^{4}} - \frac{{d}^{4} {y}_{R 1}}{d {x}^{4}} + \frac{{d}^{4} {y}_{L 2}}{d {x}^{4}} - \frac{{d}^{4} {y}_{L 1}}{d {x}^{4}} ) + α EA ( {T}_{R 2} - {T}_{R\_SFT} ) \frac{{d}^{2} {y}_{R 2}}{d {x}^{2}} - α EA ( {T}_{R 1} - {T}_{R\_SFT} ) \frac{{d}^{2} {y}_{R 1}}{d {x}^{2}} + α EA ( {T}_{L 2} - {T}_{L\_SFT} ) \frac{{d}^{2} {y}_{L 2}}{d {x}^{2}} - α EA ( {T}_{L 1} - {T}_{L\_SFT} ) \frac{{d}^{2} {y}_{L 1}}{d {x}^{2}} - {β}_{B} ( \frac{{y}_{R 2} + {y}_{L 2} - ( {y}_{R 1} + {y}_{L 1} )}{2} ) = 0 \qquad ( 6 )$$

In equation 5 and 6, right and left rail are added acting in the same direction. In that case the ballast gives the resistance indicated by β_{B}. Instead, if right and left rails are acting in opposite direction, the resistance is given by the fastening system indicated by β_{G} (gauge) in equation 7. Consequently the track gauge may also change by changed rail temperature.

$$γ EI ( \frac{{d}^{4} {y}_{R 1}}{d {x}^{4}} - \frac{{d}^{4} {y}_{L 1}}{d {x}^{4}} ) + α EA ( {T}_{R 1} - {T}_{R\_SFT} ) \frac{{d}^{2} {y}_{R 1}}{d {x}^{2}} - α EA ( {T}_{L 1} - {T}_{L\_SFT} ) \frac{{d}^{2} {y}_{L 1}}{d {x}^{2}} - {β}_{G} \frac{{y}_{R 1} + {y}_{L 1}}{2} = γ EI ( \frac{{d}^{4} {y}_{R\_SFT}}{d {x}^{4}} - \frac{{d}^{4} {y}_{L \_SFT}}{d {x}^{4}} ) - {β}_{G} \frac{{y}_{R\_SFT} + {y}_{L \_SFT}}{2} \qquad ( 7 )$$

With the same procedure as between equation 5 and 6, another time instance is included eliminating the right hand side in equation 7 resulting in equation 8.

$$γ EI ( \frac{{d}^{4} {y}_{R 2}}{d {x}^{4}} - \frac{{d}^{4} {y}_{R 1}}{d {x}^{4}} - ( \frac{{d}^{4} {y}_{L 2}}{d {x}^{4}} - \frac{{d}^{4} {y}_{L 1}}{d {x}^{4}} ) ) + α EA ( {T}_{R 2} - {T}_{R\_SFT} ) \frac{{d}^{2} {y}_{R 2}}{d {x}^{2}} - α EA ( {T}_{R 1} - {T}_{R\_SFT} ) \frac{{d}^{2} {y}_{R 1}}{d {x}^{2}}$$

$$( α EA ( {T}_{L 2} - {T}_{L\_SFT} ) \frac{{d}^{2} {y}_{L 2}}{d {x}^{2}} - α EA ( {T}_{L 1} - {T}_{L\_SFT} ) \frac{{d}^{2} {y}_{L 1}}{d {x}^{2}} ) - {β}_{G} ( \frac{{y}_{R 2} + {y}_{L 2} - ( {y}_{R 1} + {y}_{L 1} )}{2} ) = 0 ( \text{?} \\ \text{?} \text{indicates text missing or illegible when filed}$$

Further, equation 4 states that energy is preserved by the system between two states. If this is used for right and left rails at two time instances with base equation 3, equation 9 can be formulated.

$$( \begin{matrix}EI \int {γ ( \frac{{d}^{2} {y}_{R 1}}{d {x}^{2}} )}^{2} + {( \frac{{d}^{2} {y}_{L 1}}{d {x}^{2}} )}^{2} d x + \\ \int {β}_{B} ( {y}_{R 1}^{2} + {y}_{L 1}^{2} ) + {β}_{G} ( {y}_{R 1}^{2} + {y}_{L 1}^{2} ) d x + \\ α EA \int ( {T}_{R 1} - {T}_{R\_SFT} ) {( \frac{d {y}_{R 1}}{d x} )}^{2} + ( {T}_{L 1} - {T}_{L\_SFT} ) {( \frac{d {y}_{L 1}}{d x} )}^{2} d x\end{matrix} ) = ( \begin{matrix}EI \int {γ ( \frac{{d}^{2} {y}_{R 2}}{d {x}^{2}} )}^{2} + {( \frac{{d}^{2} {y}_{L 2}}{d {x}^{2}} )}^{2} d x + \\ \int {β}_{B} ( {y}_{R 2}^{2} + {y}_{L 2}^{2} ) + {β}_{G} ( {y}_{R 2}^{2} + {y}_{L 2}^{2} ) d x + \\ α EA \int ( {T}_{R 2} - {T}_{R\_SFT} ) {( \frac{d {y}_{R 2}}{d x} )}^{2} + ( {T}_{L 2} - {T}_{L\_SFT} ) {( \frac{d {y}_{L 2}}{d x} )}^{2} d x\end{matrix} ) \qquad ( 9 )$$

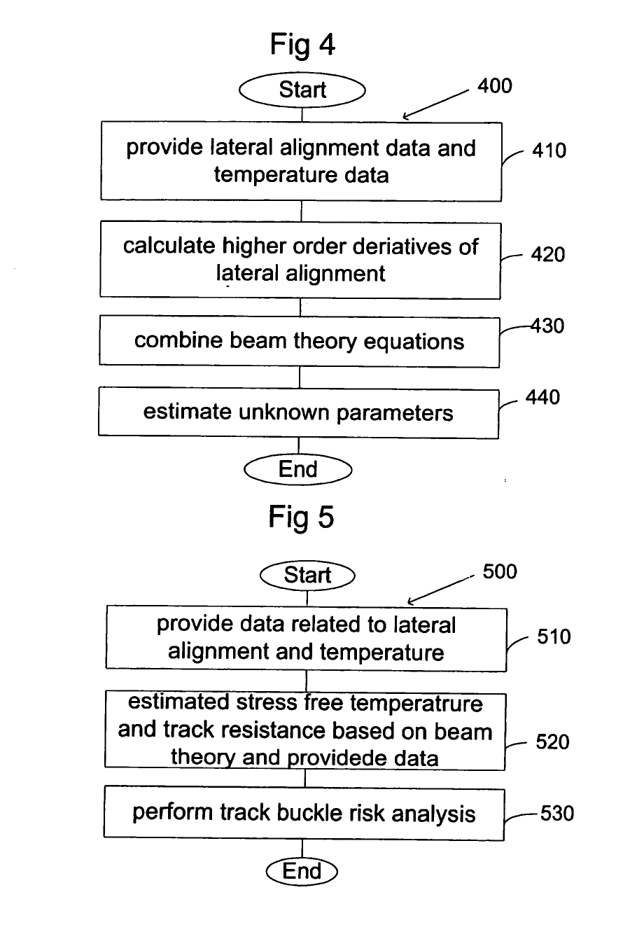

In FIG. 4, a process for determining stress free temperature and/or track resistance based on beam equations comprises the following steps.

In a first step, lateral alignment data y_{R1}, y_{R2}, y_{L1}, y_{L2} is provided for the right beam and the left beam at the time instants 1 and 2 Further, data related to the temperature T₁, T₂ at each time instant 1 and 2 is alto provided.

In a second step, higher order derivatives of the lateral alignment y_{R1}, y_{R2}, y^{L1}, y_{L2} is calculated numerically, by for example the basic formula y′=Δy/Δx.

In a third step 430, the beam equations are combined. In the example with an Euler-Bernoulli model, the equations 6, 8 and 9 are combined.

The rail may move longitudinally due to train braking and acceleration, or equalization between zones with different stress free temperatures. This is in one extended example modelled and estimated in the third step 430. The modelling and estimation of the longitudinal movement of the rail requires three or more measurements of the lateral alignment of the rail y_{R}, y_{L} and associated temperatures. A simple modelling approach is to assume that longitudinal movement of the rail is proportional to time between measurements, resulting in a corresponding change of the stress free temperature. T_{SFT} in the equations above (T_{R}_{_{—}}_{SFT}, T_{L}_{_{—}}_{SFT}) can be updated with an added T_{change} due to this longitudinal rail move as in Equation 10.

T_{SFT}=T_{SFT}_{_{—}}_{T1}+T_{change}=T_{SFT}_{_{—}}_{T1}+kₘΔt (10)

where kₘ is a linear slow-varying unknown (which is estimated) and Δt is time evolved since time 1.

In a fourth step, the unknown parameters of stress free temperature (T_{R}_{_{—}}_{SFT}, T_{L}_{_{—}}_{SFT}) and track resistance β_{B}, β_{G} and γ are estimated. If another measurement is present at another rail temperature T₃, more equations and a better estimate may be calculated.

Solving the equations for the unknowns is a numerical problem. A new solution can be calculated for each sample of measurement along the track. Different numerical methods are available for the calculation as for example Kalman filters. The unknown parameters have a slow variation from sample to sample. Therefore consecutive equations are correlated.

In FIG. 5, a process for performing track buckle risk analysis is described. In a first step 510, data of track geometry quality and associated temperature is collected for at least two different occasions. In a second step 520, a value for stress free temperature and track resistance is estimated for a number of points along a track. The estimation of the stress free temperature and the track resistance is determined based on track geometry quality data related to the measurements at the at least first temperature T₁ and at the second temperature T₂. The estimation of the stress free temperature and the track resistance is in one example provided using the models relating measurements with the parameters of stress free temperature and track resistance described above. In a third step 530, it is predicted at which rail-temperature, or at which combination of rail-temperature and decreased track resistance track-buckles may occur along the track. In one example, this means that the variation of the lateral alignment is studied using measured lateral alignment as a starting point. Thus, when the parameters of stress free temperature and track resistance are found along a track, a track buckle risk analysis can be performed in order to find which parts of the track are closest to a track buckle situation based on the variation of the lateral alignment. Track resistance may be non-linearly modelled for better risk assessment.

By performing parametric studies sensitivity of certain parameters may be checked. In one example the sensitivity to rail temperature is checked. For example, high summer temperatures may be simulated by increasing the value of the rail temperature in the beam equations and study the influence on the lateral alignment of the rail. Alternatively, the result on the lateral alignment when decreasing the track resistance can be checked. For example, this can be used for simulating maintenance work.

### One Example of Implementing the Solution

In the example of two measurements y_{R1}, y_{R2}, y_{L1}, y_{L2} are all known and their higher derivatives can be numerically calculated. Also rail-temperature is measured and the higher order differential equations will transfer to a system of equations without differentials. As an example, equations 6 and 8 are used in the following (extended with gamma for each rail—γ_{R} and γ_{L}. Of many possible ways of solving the equations, Kalman filter is one possibility. The equations are rewritten into state-space form as in Equations 11-15.

$$\begin{matrix}z ( n + 1 ) = Fx ( n ) + w ( n ) \\ y ( n + 1 ) = Hx ( n ) + v ( n ) & ( 11 ) \\ {z}^{T} = [ {T}_{R\_SFT} , {T}_{L\_SFT} , {β}_{B} , {β}_{G} , {γ}_{R} , {γ}_{L} ] & ( 12 ) \\ F = [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ] & ( 13 ) \\ H = [ \begin{matrix}- \frac{α A}{I} ( {y}_{R 2}^{″} - {y}_{R 1}^{″} ) & - \frac{α A}{I} ( {y}_{L 2}^{″} - {y}_{L 1}^{″} ) & \frac{{y}_{R 2} + {y}_{L 2} - ( {y}_{R 1} + {y}_{L 1} )}{2 EI} & 0 & {y}_{R 2}^{( 4 )} - {y}_{R 1}^{( 4 )} & {y}_{L 2}^{( 4 )} - {y}_{L 1}^{( 4 )} \\ - \frac{α A}{I} ( {y}_{R 2}^{″} + {y}_{R 1}^{″} ) & - \frac{α A}{I} ( {y}_{L 2}^{″} + {y}_{L 1}^{″} ) & 0 & \frac{{y}_{R 2} - {y}_{L 2} - ( {y}_{R 1} - {y}_{L 1} )}{2 EI} & {y}_{R 2}^{( 4 )} + {y}_{R 1}^{( 4 )} & {y}_{L 2}^{( 4 )} + {y}_{L 1}^{( 4 )}\end{matrix} ] & ( 14 ) \\ y = [ \begin{matrix}- \frac{α A}{I} ( {T}_{R 2} {y}_{R 2}^{″} + {T}_{L 2} {y}_{L 2}^{″} - {T}_{R 1} {y}_{R 1}^{″} - {T}_{L 1} {y}_{L 1}^{″} ) \\ - \frac{α A}{I} ( {T}_{R 2} {y}_{R 2}^{″} - {T}_{L 2} {y}_{L 2}^{″} - {T}_{R 1} {y}_{R 1}^{″} + {T}_{L 1} {y}_{L 1}^{″} )\end{matrix} ] & ( 15 )\end{matrix}$$

w(n) and v(n) are process and measurement noise. It is possible to model and estimate these as well; however, estimating them will result in a non-linear problem and other techniques as for example Extended Kalman Filter, Unscented Kalman filter or Particle Fitter may be used.

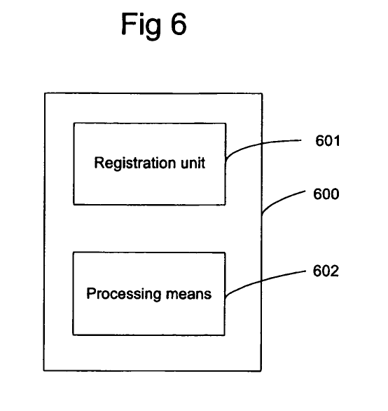

In FIG. 6, a device 600 for determining at least a first parameter of a track, comprises a registration unit 601 and processing means 602. The registration unit 601 is arranged to register first track geometry quality data along with associated first temperature data and second track geometry quality data along with associated second temperature data. The processing means 602 are arranged to set up a model relating the first and second track geometry quality data with associated temperatures to stress free temperature and/or track resistance, and to estimate stress free temperature and/or track resistance in said at least one point based on the model.

1. Method for determining at least a first parameter of a track, comprising:
providing first track geometry quality data associated to at least one point along a rail at a first temperature,
providing second track geometry quality data associated to said at least one point at a second temperature,
describing a difference between the first and second track geometry quality data by means of a model relating the measured first and second track geometry quality data with associated measured temperatures to the unknown parameters of the model; stress free temperature and/or track resistance, and
estimating the stress free temperature and/or track resistance in said at least one point based on the measurements and the model.

2. The method according to claim 1, wherein the track geometry data comprises lateral alignment of the rail.

3. The method according to claim 1, wherein the model is a beam model.

4. The method according to claim 3, wherein the beam model is an Euler-Bernoulli model.

5. The method according to claim 3 wherein the step of estimating stress free temperature and/or track resistance comprises numerically calculating higher derivatives of lateral alignment so as to provide beam theory equations without differentials.

6. The method according claim 1,
wherein the step of providing first track geometry quality data comprises providing a first series of track geometry quality data comprising data associated to a plurality of first measure points along the rail,
wherein the step of providing second track geometry quality data comprises providing a second series of track geometry quality data comprising data associated to a plurality of second measure points along the rail, and
further comprising a step of correlating the first series track geometry quality data with the second series track geometry quality data.

7. The method according to claim 6, comprising the steps of:
providing a measure of the first temperature at each first measure point and associating the first temperature value with the corresponding first track geometry quality data, and
providing a measure of the second temperature at each second measure point and associating the second temperature value with the corresponding second track geometry quality data.

8. The method according to claim 1, further comprising the steps of performing track buckle risk analysis based on the model.

9. The method according to claim 8, wherein the step of performing track buckle risk analysis comprises:
inserting the estimated stress free temperature and track resistance in each said at least one point in the model, and
determining the sensitivity of alignment of the rail to variation of track buckling parameters such as temperature and/or track resistance based on the model.

10. The method according to claim 2, wherein the model is a beam model.

11. The method according to claim 4, wherein the step of estimating stress free temperature and/or track resistance comprises numerically calculating higher derivatives of lateral alignment so as to provide beam theory equations without differentials.

12. The method for determining at least a first parameter of a track, comprising:
providing first track geometry quality data associated to at least one point along a rail at a first temperature,
providing second track geometry quality data associated to said at least one point at a second temperature
describing a difference between the first and second track geometry quality data by means of a model relating the measured first and second track geometry quality data with associated measured temperatures to the unknown parameters of the model; stress free temperature and/or track resistance, and
estimating the stress free temperature and/or track resistance in said at least one point based on the measurements and the model,
wherein the step of providing first track geometry quality data comprises providing a first series of track geometry quality data comprising data associated to a plurality of first measure points along the rail,
wherein the step of providing second track geometry quality data comprises providing a second series of track geometry quality data comprising data associated to a plurality of second measure points along the rail, and
further comprising a step of correlating the first series track geometry quality data with the second series track geometry quality data.

13. The method according to claim 12, further comprising the steps of performing track buckle risk analysis based on the model.

14. The method according to claim 13, wherein the track geometry data comprises lateral alignment of the rail.

15. The method according to claim 13, wherein the model is a beam model.

16. The method according to claim 14, wherein the beam model is an Euler-Bernoulli model.

17. The method according to claim 12, wherein the step of estimating stress free temperature and/or track resistance comprises numerically calculating higher derivatives of lateral alignment so as to provide beam theory equations without differentials.

18. A device for determining at least a first parameter of a track, comprising:
a registration unit arranged to register first track geometry quality data along with associated first temperature data and second track geometry quality data along with associated second temperature data, and
processing means arranged to set up a model relating the first and second track geometry quality data with associated temperatures to stress free temperature and/or track resistance, and to estimate stress free temperature and/or track resistance in said at least one point based on the model.
